(19) United States
(12) Patent Application Publication
(10) Pub. No.: US 2005/0189378 A1
(43) Pub. Date: Sep. 1, 2005

(54) Fluid container

(76) Inventors: Anthony Eluck, Keswick (CA); Corey Katz, Toronto (CA)

Correspondence Address: BERESKIN AND PARR, 40 KING STREET WEST, BOX 401, TORONTO, ON, M5H 3Y2, CA

(21) Appl. No.: 10/787,313

(22) Filed: Feb. 27, 2004

(51) Int. Cl. B67D 1/00

(52) U.S. Cl. 222/78; 222/321.9

(57) ABSTRACT

A fluid container having an internal display substrate disposed within the internal volume of the container. The internal display substrate is preferably spaced from both the front and the back of the container, the spacing being maintained by the shape of the container, or by a combination of the shape of the container and the position of a feed tube associated with a pump for use with the container, or by retaining members disposed within the container. The internal display substrate is suitable for displaying a graphic. A fluid container having an integral air freshener is also disclosed, in which the air freshening effect may be provided by the fluid within the container.

### FIELD OF THE INVENTION

The present invention relates to fluid containers. More particularly, it relates to fluid containers with graphical or other images.

### BACKGROUND OF THE INVENTION

Fluid containers, such as bottles, are used to hold various types of liquids and other fluids. It is known to place graphics on these containers in order to improve their visual appeal. It is also known to utilize a transparent or translucent container, and, where the liquid contained therein is also transparent or translucent, to place a graphic on the surface of the container so that the graphic is visible from the opposing side of the bottle through the transparent or translucent material of the container and the transparent or translucent liquid contained therein. The present invention provides, in addition to other advantages that will become apparent to one skilled in the art upon review of the detailed description, a fluid container with an internal display substrate within a the container such that a graphic can be displayed within the volume of the container itself rather than merely on its surfaces.

It is also known in the art to combine a fluid container with an air freshener. Conventionally, such a combination has taken the form of, for example, a soap dispenser bottle comprising a top portion containing soap and a separate bottom portion having ventilation ports therein. A discrete air freshener, of a type known in the art, is disposed within this bottom portion. Of course, the top portion will not be in fluid communication with the bottom, or else the soap would escape from the ventilation ports, which is undesirable.

### SUMMARY OF THE INVENTION

In one aspect, the invention comprises a fluid container having a body defining an interior volume, the bottle also having an internal display substrate disposed within the interior volume.

In another aspect, the invention comprises a fluid container defining an interior volume and having a back and a convex front having a curvature, the internal volume comprising a rear volume proximate to the back of the bottle, a front volume proximate to the front of the bottle, and a medial volume between the rear volume and the front volume, the fluid container also having an internal display substrate moveably disposed in its interior volume, wherein movement of the internal display substrate from said medial volume into said front volume is limited by the curvature of the convex front.

In a further aspect, the invention comprises a method of installing an internal display substrate constructed of a flexible material and being biased to maintain a planar shape in a fluid container that defines an interior space and has an opening for receiving a cover or a pump, the method comprising: compacting the internal display substrate into a shape that is sufficiently small to permit the compacted internal display substrate to fit through the opening; moving the internal display substrate completely through the opening so that the internal display substrate is disposed entirely within the interior space; releasing the internal display substrate; and agitating the fluid container.

In yet another aspect, the invention comprises a fluid container having a body defining an interior volume wherein at least part of the body is composed of a material that is liquid impervious and vapour pervious.

In a still further aspect, the invention comprises a fluid container having a body defining an interior volume and having an interior surface and at least one opening defined in the body, and also having at least one piece of material that is liquid impervious and vapour pervious wherein said piece of material is sealingly secured to said interior surface so as to define a barrier between said at least one opening and said internal volume that is liquid impervious and vapour pervious.

### BRIEF DESCRIPTION OF THE DRAWINGS

FIG. 1 is a front cross-sectional view of a fluid container having an internal display substrate;

FIG. 2 is a top cross-sectional view of a fluid container having an internal display substrate with the pump mechanism shown in relief;

FIG. 3 is a side cross-sectional view of a fluid container having an internal display substrate;

FIG. 4A is an internal display substrate;

FIG. 4B is a perspective view of a fluid container having an internal display substrate;

FIG. 5 illustrates a method of installing an internal display substrate in a fluid container; and

FIGS. 6 and 7 are front views of alternative internal display substrates according to the present invention.

FIGS. 8 and 9 are front cross-sectional views of fluid containers.

### DETAILED DESCRIPTION OF EXEMPLARY EMBODIMENTS

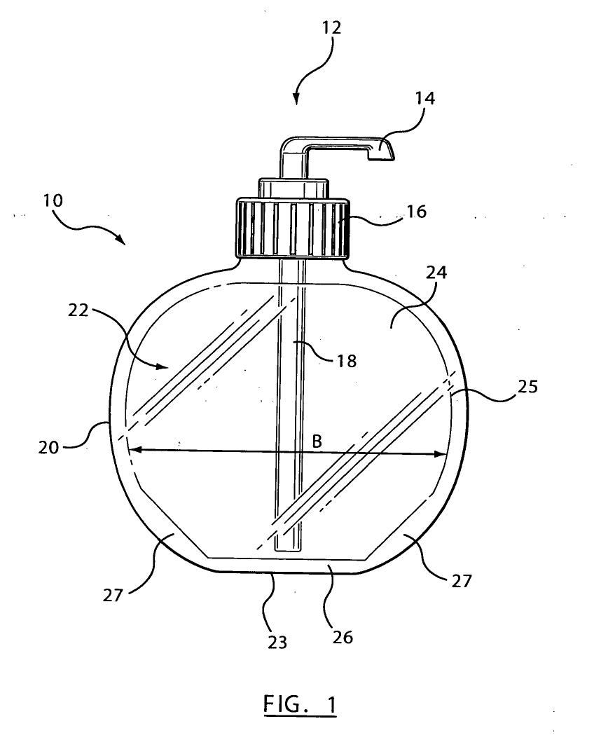

Referring first to FIG. 1, a fluid container is indicated generally at 10. The container 10 has a pump 12 comprising a spout 14, a screw-mounting 16, and a depending feed tube 18. It will be appreciated by one skilled in the art that the pump 12 forms no part of the present invention, and that any pump known in the art may be used. Additionally, the present invention may be used in the absence of a pump.

The container 10 has a body 20, which defines an interior volume 22. Body 20 also defines an interior bottom surface 23. Preferably, container 10 is formed of a transparent or translucent material.

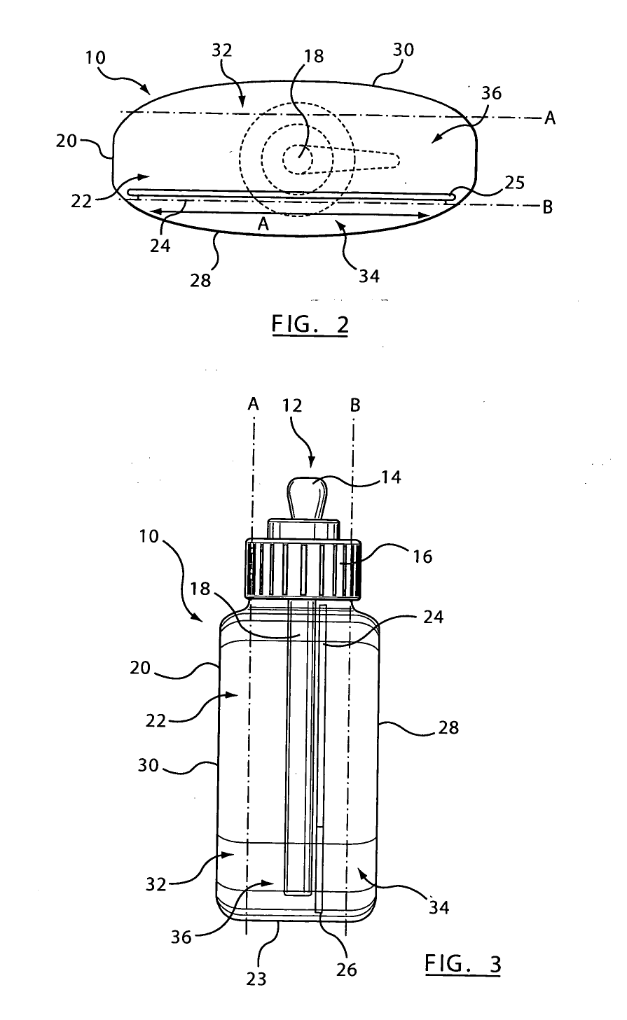

Disposed within interior volume 22 of container 10 is an interior display substrate 24. Internal display substrate 24 has a perimeter 25, which preferably (as shown in FIG. 1) conforms substantially to a cross section of interior volume 22. The cross section to which internal display substrate conforms, in this embodiment is illustrated in FIG. 2.

Still referring to FIG. 1, perimeter 25 has bottom portion 26. Preferably, the shape of bottom portion 26 of perimeter 25 conforms generally to the shape of interior bottom surface 23 so that internal display substrate 24 may rest on bottom surface 23 in a relatively stable manner.

It is desirable that internal display substrate 24 be shaped so as to permit substantially all liquid contained in container 10 to be withdrawn. A preferred method of achieving this result is shown in FIG. 1. Internal display substrate 24 does not conform completely with the cross section of interior volume 22. Instead, perimeter 25 of internal display substrate 24 deviates from conformance with the cross section of interior volume 22 toward the sides of bottom portion 26 of perimeter 25, near the bottom of container 10, creating passages 27. Passages 27 facilitate circulation of liquid throughout container 10, which prevents a substantial portion of liquid from becoming isolated from the intake of feed tube 18.

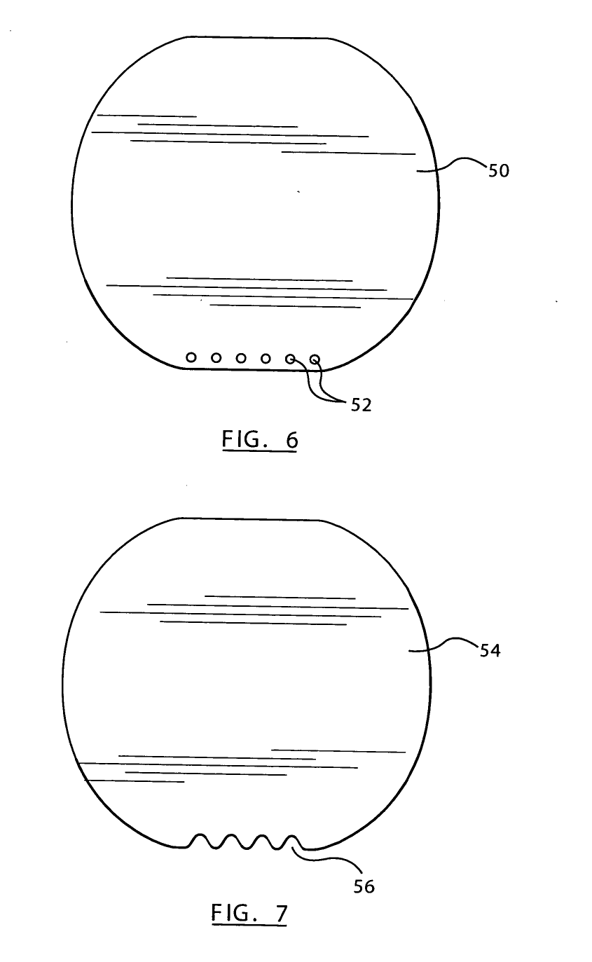

It will be appreciated by one skilled in the art that many alternate techniques are available for permitting substantially all liquid to be withdrawn, including forming holes 52 in an alternate internal display substrate 50, as shown in FIG. 6, or forming recesses 56 along the bottom portion 26 of another alternative interior display substrate 54, as shown in FIG. 7.

As seen in FIG. 2, container 10 has a front 28. Front 28 may be convex such that movement of internal display substrate 24 toward front 28 is limited by the curvature of front 28. Specifically, the curvature of front 28 results in a narrowing of width A of front 28 so that as internal display substrate 24 moves toward curved front 28, there is a position at which the width B (FIG. 1) of internal display substrate 24 is equal to the width A of (curved) front 28 such that further movement of internal display substrate 24 toward curved front 28 is prevented. The precise location at which motion of internal display substrate 24 is arrested is not of particular importance, as long as internal display substrate 24 is prevented from moving past a position that is generally spaced from front 28 as shown in FIG. 2.

Container 10 also has a back 30, and, as also shown in FIG. 2, movement of internal display substrate 24 toward back 30 may be limited by depending feed tube 18. Alternatively (not shown), back 30 may be convex (in a manner similar to that shown for front 28) such that movement of internal display substrate 24 toward back 30 is similarly limited by a curvature of back 30. By curving back 30, the use of a feed tube that is integrally formed into body 20 is facilitated while still limiting movement of internal display substrate 24 toward back 30. Such an integrally formed feed tube would have the advantage of being substantially invisible to a casual observer of container 10. It will be appreciated by one skilled in the art that where both front 28 and back 30 are convex, they may, but need not, have identical curvatures.

An alternative (not shown) to front 28 being curved is to use internal posts or indentations formed as part of the interior portion of body 20. These internal posts would protrude into internal volume 22 to limit the motion of internal display substrate 24. Posts or indentations formed into or mounted on the inside of body 20 could also be used for back 30 in the case of an integral feed tube.

Now referring to FIGS. 2 and 3, to further explain the operation of the above aspect of the invention, internal volume 22 of container 10 may be notionally divided by lines C and D into a rear volume 32 proximate to back 30, a front volume 34 proximate to front 28, and a medial volume 36 located between rear volume 32 and front volume 34. As can be seen in FIG. 2, and as explained above, where front 28 is convex, movement of internal display substrate 24 from medial volume 36 into front volume 34 is limited by the curvature of front 28.

Also, as shown in FIG. 2 and explained above, where depending feed tube 18 is present, movement of internal display substrate 24 from medial volume 36 into rear volume 32 is limited by depending feed tube 18. In fact, in the embodiment shown, movement of internal display substrate within medial volume 36 is limited by feed tube 18.) Alternatively, back 30 may be curved such that movement of internal display substrate 24 from medial volume 36 into rear volume 32 is limited by the curvature of back 30.

Thus, by using a convex front 28, and feed tube 18 (or by making back 30 convex), internal display substrate 24 can be maintained in a generally upright position within container 10, and kept within medial volume 36 of interior volume 22 so that it is visibly spaced from front 28 and back 30 of container 10.

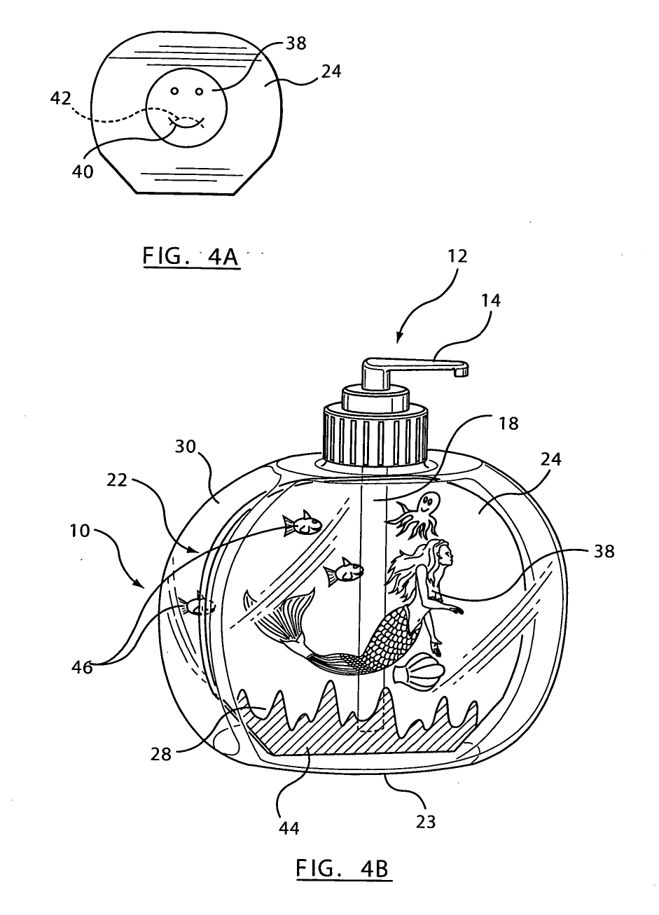

Substrate 24 is suitable for having a graphic 38 disposed thereon, and permits graphic 38 to be placed within the interior volume 22 of container 10, rather than merely on an interior or exterior surface of body 20. There are numerous potential advantages for such a display of a graphic. For example, referring now to FIG. 4A, internal display substrate 24 has graphic 38 disposed thereon. Graphic 38 could be liquid sensitive such that graphic 38 displays a first image 40 when graphic 38 is immersed in liquid and a second image 42 (shown in dotted form) when graphic 38 is exposed to air. This will permit the graphic 38 to change as liquid in container 12 is dispensed, providing a visual indicator to a user as to when replenishment of the liquid will be required. This could be especially helpful where the liquid is transparent. Means for making a graphic sensitive to liquids are known in the art. Graphic 38 could, alternatively, be used to indicate expiry of a product contained in container 10. In such a case, graphic 38 would display first image 40 at an initial time T which could fade to reveal second image 42 at time T+N, where N is a predetermined time interval. Means for creating a graphic that will fade over time are known in the art. One skilled in the art will appreciate that graphic 38 may be integral with internal display substrate 24, for example where internal display substrate 24 is formed of a translucent plastic, which changes colour depending on whether it is exposed to air or liquid. In such a case, first image 40 would be a first colour, and second image 42 would be a second colour.

The use of internal display substrate 24 to permit a graphic 38 to be placed inside interior volume 22 of container 10 has an additional advantage. It is known in the art to place graphics on the front and back of a container in an attempt to create a composite image having an impression of depth. Disposing graphic 38 on internal display substrate 24 allows the creation of an image having a more genuine depth impression. Referring now to FIG. 4B, graphic 38 is disposed on internal display substrate 24, which is disposed in interior volume 22 of container 10. Foreground graphic 44 is disposed on front 28, and background graphic 46 is disposed on back 30. This results in three layers of images, with each layer spaced from the others. This in turn produces a composite image having a superior impression of depth. It will be appreciated by one skilled in the art that graphic 38 could be used with only foreground graphic 44, or only background graphic 46, without departing from the scope of the present invention.

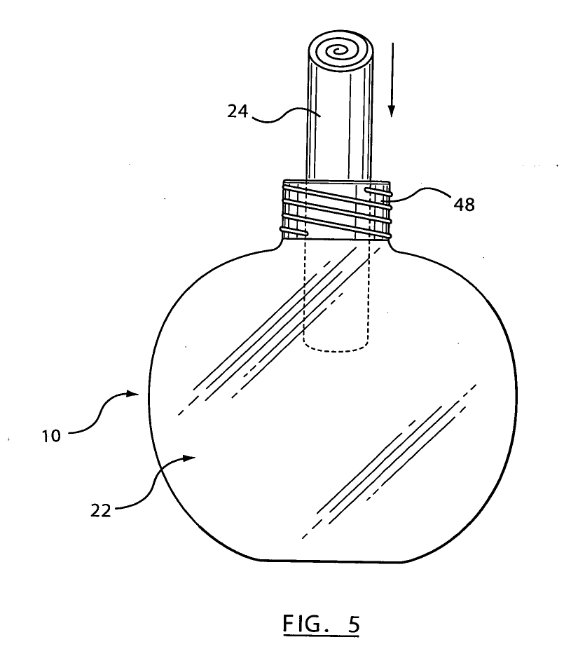

In another aspect, the present invention relates to a method of installing an internal display substrate in a fluid container. Referring now to FIG. 5, container 10 has an opening 48 for receiving pump 12. While FIG. 5 depicts a screw mounting, it will be appreciated by one skilled in the art that the particular means of mounting used forms no part of the present invention. Alternatively, pump 12 could be mounted on container 10 with a friction fit or an interference fit.

Reference is made to FIG. 5, which illustrates the process of installing internal display substrate 24 in container 10. Internal display substrate 24 is preferably composed of a flexible material such as plastic, and is preferably biased to maintain a generally planar shape. More preferably, internal display substrate 24 is constructed of a flexible plastic that exhibits a shape memory in that it tends to substantially return to its original shape when folded or rolled.

Installation of internal display substrate 24 in container 10 is achieved by compacting internal display substrate 24 into a shape that is sufficiently small to fit through opening 48, moving the compacted internal display substrate 24 completely through opening 48 so that the compacted internal display substrate 24 is disposed entirely within interior volume 22 and then allowing internal display substrate 24 to return to its original generally planar shape. Optionally, container 10 may be agitated (i.e. shaken or otherwise moved) to assist internal display substrate in returning to its original shape and in orienting internal display substrate 24 within interior volume 22 of container 10. The compacting step may comprise rolling internal display substrate 24 into a generally tubular shape having a diameter that is sufficiently small to permit the compacted internal display substrate 24 to fit through opening 48, although other, less preferable methods, such as fan folding internal display substrate 24, may be used.

Container 10 has been described as being used with liquid fluids. A container according to the present invention may also be used with gaseous and other fluids. Other containers according to the present invention may be designed with an opening at the base, allowing the container to rest on a cap installed on the base. Another container according to the present invention may include a chamber into which a fragrant air freshener may be inserted. The chamber will typically be detached from the interior volume 22 of the container, and may be formed by attaching an auxiliary cover to the container 10.

In another aspect, the present invention comprises a fluid container having a body defining an interior volume wherein at least part of said body is composed of a material that is fluid impervious and vapour pervious. Such materials are known in the art.

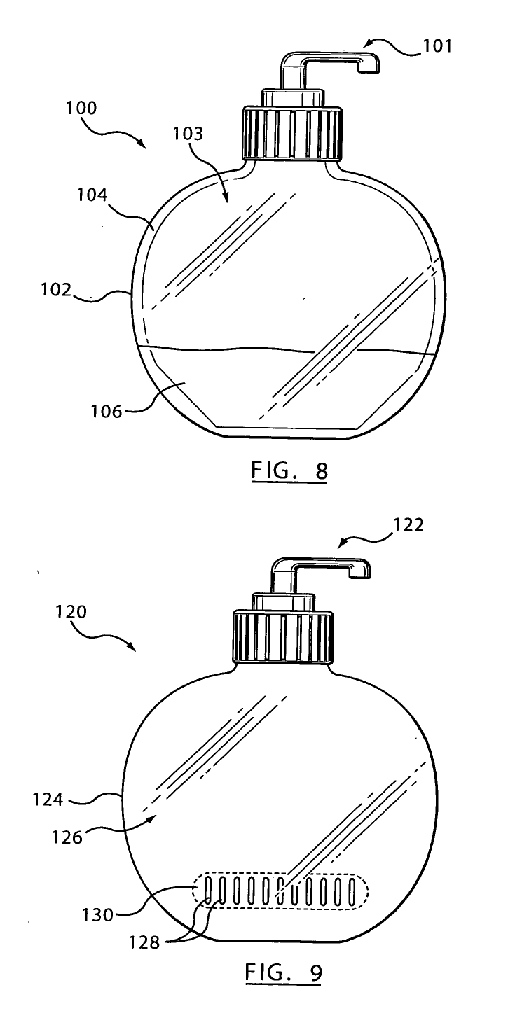

Referring now to FIG. 8, another preferred embodiment of a fluid container is indicated generally at 100. (It will be understood by one skilled in the art that the pump mechanism shown generally at 101 forms no part of the present invention.) Fluid container 100 has a body 102 defining an interior volume 103. Body 102 comprises an upper portion 104 and a lower portion 106. In a preferred embodiment, lower portion 106 is composed of a material that is fluid impervious and vapour pervious. When interior volume 103 of container 102 is filled with a fragrant liquid, the liquid will remain confined to container 102 because of the liquid impervious nature of the material from which lower portion 106 is constructed, but the fragrance of the liquid will be able to escape into the surrounding environment because lower portion 106 is vapour pervious. In the embodiment described above, it will be understood that upper portion 104 is composed of a material that is liquid impervious, although it is not necessarily vapour pervious. Similarly, it will be understood that upper portion 104 and lower portion 106 are sealed to each other so that body 102 is liquid-tight, and that upper portion 104 and lower portion 106 are in fluid communication with one another. Being fluid-tight does not, of course, preclude an opening disposed on body 102 by means of which fluid may be deliberately removed from interior volume 103, for example by means of pump 101.

Now referring to FIG. 9, another preferred embodiment of the present invention is shown. A fluid container according to the present invention is indicated generally at 120, and has pump mechanism 122 (which forms no part of the present invention). Fluid container 120 has body 124, which defines interior volume 126. Body 124 is composed of a liquid and vapour impervious material, and defines at least one opening 128. In the embodiment shown in FIG. 9, there are a plurality of openings 128. Liquid is prevented from escaping from interior volume 126 through openings 128 by strip 130, which is composed of a material that is fluid impervious and vapour pervious and which is sealingly secured to the interior surface of body 124 in a liquid-tight manner. Thus, strip 130 defines a barrier between said openings and said internal volume that is liquid impervious and vapour pervious, so that liquid will be contained within fluid container 120, but vapour will be permitted to escape into the environment by penetrating vapour pervious strip 130 and escaping through openings 128. By varying the number and size of openings 128, it is possible to control the rate at which vapour is released into the environment. The combination of openings 128 with a fluid impervious and vapour pervious strip 130 can be used with a one-piece fluid container, or with fluid containers having more than piece (for example a clear plastic upper portion and an opaque plastic base in fluid communication with each other).

When fluid container 100 or 120 is filled with, for example, a liquid soap having a pleasing fragrance, the fragrance of the soap will be able to escape through vapour pervious lower portion 106 or strip 130 and openings 128 into the environment, which is presumably filled with breathable air, so that a person in the general vicinity of fluid container 100 will detect the fragrance when breathing through his or her nose. In other words, when fluid container 100 or 120 is filled with fragrant liquid soap it can have an air freshener effect. Thus, fluid container 100 or 120 can be used as a combination air freshener and soap dispenser.

Fluid containers 100 and 120 are advantageous in that they permit all of interior volume 103 or 126 to be filled with liquid, and do not require that a portion of interior volume be segregated for containing a a conventional air freshener. Thus, more liquid can be held in a container of the same size while still providing an air freshening capability. Moreover, the use of fluid containers according to the present invention as a combination soap dispenser and air freshener ensures that the air freshening fragrance and the soap fragrance will be a perfect match, because they are in fact the same fragrance.

It will be understood by one skilled in the art that alternate embodiments are within the scope of the present invention. For example, body 102 of fluid container 100 could be composed entirely of a material that is fluid impervious and vapour pervious. Similarly, for fluid container 100, upper portion 104 could be composed of a material that is fluid impervious and vapour pervious, and lower portion 106 composed of material that is liquid impervious but not necessarily vapour pervious. Moreover, for fluid container 120, openings 128 (and of course, strip 130) may be placed at any location on body 124 that will permit vapour to escape into the environment.

It will also be understood by one skilled in the art that a fluid container 100 or 120 may have an internal display substrate disposed within interior volume 103 or 126, in accordance with the present invention (not shown).

Exemplary embodiments of the present invention have been described. Several variations of the invention have also been described. Other variations of the invention are possible, and fall within the scope of the present invention, which is limited only by the following claims.

1. A fluid container having a body defining an interior volume, said container having an internal display substrate disposed within said interior volume.

2. The fluid container of claim 1 wherein said internal display substrate is shaped to so as to permit substantially all liquid contained in said container to be withdrawn.

3. The fluid container of claim 2 wherein one or more openings are formed in the substrate for allowing said liquid to pass through said substrate.

4. The fluid container of claim 2 wherein at least a portion of the perimeter of the substrate is spaced apart from the body of the fluid container.

5. The fluid container of claim 1 wherein said internal display substrate is moveably disposed within said interior volume.

6. The fluid container of claim 1 wherein said internal display substrate has a perimeter, said perimeter conforming at least in part to a cross section of said interior volume.

7. The fluid container of claim 6 wherein the perimeter substantially conforms to the cross section.

8. The fluid container of claim 6 wherein one or more openings are formed in the substrate for allowing said liquid to pass through said substrate.

9. The fluid container of claim 6 wherein at least a portion of the perimeter of the substrate is spaced apart from the body of the fluid container.

10. The fluid container of claim 5 wherein said container has a convex front having a curvature and wherein movement of said internal display substrate toward said front is limited by said curvature.

11. The fluid container of claim 5 wherein said container has a back, and a dispensing pump positioned at a top of said container, said dispensing pump having a feed tube depending therefrom, and wherein movement of said internal display substrate toward said back is limited by said feed tube.

12. The fluid container of claim 5 wherein said container has a convex back having a curvature and wherein movement of said internal display substrate toward said back is limited by said curvature.

13. The fluid container of claim 5 wherein said body comprises a front and further comprises internal guides integrally formed as part of said body, said guides protruding into said internal volume, such that said guides arrest movement of said internal display substrate toward said front.

14. The fluid container of claim 1 wherein said internal display substrate is an integrally formed with said body.

15. The fluid container of claim 1 wherein said internal display substrate has a graphic disposed thereon, said graphic being liquid sensitive such that a first portion of said graphic displays a first image when said first portion is exposed to a liquid and a second portion that displays a second image when said graphic is exposed to air.

16. The fluid container of claim 1 wherein said internal display substrate has a graphic disposed thereon, said graphic changing over time such that said graphic displays a first image at time T=0 and a second image at time T=N, where N is a predetermined time interval.

17. The fluid container of claim 1 further comprising a front, wherein said front has a first graphic disposed thereon, and said internal display substrate has a second graphic disposed thereon.

18. The fluid container of claim 1 further comprising a back, wherein said back has a first graphic disposed thereon, and said internal display substrate has a second graphic disposed thereon.

19. The fluid container of claim 1 further comprising a front and a back, wherein said front has a first graphic disposed thereon, said internal display substrate has a second graphic disposed thereon, and said back has a third graphic disposed thereon.

20. A fluid container defining an interior volume and having a back and a convex front having a curvature, said internal volume comprising a rear volume proximate to said back, a front volume proximate to said front, and a medial volume between said rear volume and said front volume, said fluid container having an internal display substrate moveably disposed in said interior volume, wherein movement of said internal display substrate from said medial volume into said front volume is limited by said curvature.

21. The fluid container of claim 20 wherein said back is a convex back having a second curvature, and wherein movement of said internal display substrate from said medial volume into said rear volume is limited by said second curvature.

22. The fluid container of claim 20 further comprising a pump positioned at a top thereof, said pump having a feed tube depending therefrom, wherein movement of said internal display substrate from said medial volume into said rear volume is limited by said feed tube.

23. A method of installing an internal display substrate in a fluid container, said fluid container defining an interior space and having an opening for receiving a pump, said internal display substrate being constructed of a flexible material and being biased to maintain a planar shape, the method comprising: compacting said internal display substrate into a shape that is sufficiently small to permit said compacted internal display substrate to fit through said opening; moving said internal display substrate completely through said opening so that said internal display substrate is disposed entirely within said interior space; releasing said internal display substrate; and agitating said fluid container.

24. The method of claim 23 wherein said compacting step comprises rolling said internal display substrate into a tubular shape having a diameter that is sufficiently small to permit said rolled internal display substrate to fit through said opening.
The method of claim 23 wherein said compacting step comprises fan-folding said internal display substrate.

25. A fluid container having a body defining an interior volume wherein at least part of said body is composed of a material that is liquid impervious and vapour pervious.

26. The fluid container of claim 25 wherein said body comprises an upper portion and a lower portion, and said at least part of said body that is composed of a material that is liquid impervious and vapour pervious is said lower part of said body.

27. The fluid container of claim 26 wherein said body comprises an upper portion and a lower portion, and said at least part of said body that is composed of a material that is liquid impervious and vapour pervious is said upper part of said body.

28. A fluid container comprising
(a) a body defining an interior volume and having an interior surface;
(b) at least one opening defined in said body;
(c) at least one piece of material that is liquid impervious and vapour pervious;
wherein said piece of material is sealingly secured to said interior surface so as to define a barrier between said at least one opening and said internal volume that is liquid impervious and vapour pervious.
